(19) United States
(12) Patent Application Publication
(10) Pub. No.: US 2020/0174312 A1
(43) Pub. Date: Jun. 4, 2020

(54) DISPLAY DEVICE

(71) Applicant: SHARP KABUSHIKI KAISHA, Sakai City, Osaka (JP)

(72) Inventors: HIROMI ENOMOTO, Sakai City, Osaka (JP); TOKUMI HAYASHI, Sakai City, Osaka (JP); KOHJI MICHIBAYASHI, Sakai City, Osaka (JP); MASAHIRO OKUNO, Sakai City, Osaka (JP)

(21) Appl. No.: 16/615,229

(22) PCT Filed: May 18, 2018
(86) PCT No.: PCT/JP2018/019280

§ 371 Date: Nov. 20, 2019

(30) Foreign Application Priority Data
May 25, 2017 (JP) 2017-103625

(51) Int. Cl. G02F 1/1335; G02F 1/13363

(52) U.S. Cl. CPC G02F 1/133528; G02F 2001/133531; G02F 2001/133638; G02F 1/13363

(57) ABSTRACT

A display device includes: a display panel including a light reflection part by which light from a display surface side is reflected, and a light transmission part through which light from an opposite side from the display surface side passes; a quarter wave plate disposed on the display panel at an opposite side from the display surface side; and a polarizing plate disposed on the quarter wave plate at an opposite side from a display panel side, the polarizing plate having an absorption axis whose crossing angle relative to a slow axis of the quarter wave plate is set such that light passing through the polarizing plate and then passing through the quarter wave plate is converted into elliptically polarized light.

### TECHNICAL FIELD

The present invention relates to a display device.

### BACKGROUND ART

As an example of a phase difference plate of a conventional display device, there has been known one disclosed in Patent Document 1 listed below. A phase difference plate of a display device disclosed in Patent Document 1 is a phase difference plate for a circularly polarizing plate. The phase difference plate includes a first optically anisotropic layer and a second optically anisotropic layer. Each of the first optically anisotropic layer and the second optically anisotropic layer contains a liquid crystal compound that is helically aligned around a helical axis which is in a thickness direction of each of the layers. A helix direction of the liquid crystal compound in the first optically anisotropic layer is equal to a helix direction of the liquid crystal compound in the second optically anisotropic layer. A helix angle of the liquid crystal compound in the first optically anisotropic layer is 26.5±10.0°. A helix angle of the liquid crystal compound in the second optically anisotropic layer is 78.6±10.0°. An in-plane slow axis in a surface of the first optically anisotropic layer at the second optically anisotropic layer side is in parallel with an in-plane slow axis in a surface of the second optically anisotropic layer at the first optically anisotropic layer side. A value of a product Δn·d of a refractive index anisotropy Δn of each of the first optically anisotropic layer and the second optically anisotropic layer and a thickness d of each of the first optically anisotropic layer and the second optically anisotropic layer falls within a predetermined range.

### RELATED ART DOCUMENT

### Patent Document

Patent Document 1: Japanese Unexamined Patent Application Publication No. 2014-209220

### Problem to be Solved by the Invention

The foregoing technique disclosed in Patent Document 1 has been devised for suppressing coloring in black in the front surface direction in mounting the phase difference plate as a circularly polarizing plate on a display device. In contrast, a transflective liquid crystal display device configured to carry out reflective display and transmissive display has a problem in that leakage light to be caused not a little during black display is visually recognized with a specific hue. It has been difficult for the technique disclosed in Patent Document 1 to solve such a problem.

### DISCLOSURE OF THE PRESENT INVENTION

The present invention has been completed based on the circumstance described above. An object of the present invention is to make leakage light less prone to be visually recognized with a specific hue.

### Means for Solving the Problem

A display device according to the present invention includes: a display panel including a light reflection part by which light from a display surface side is reflected, and a light transmission part through which light from an opposite side from the display surface side passes; a quarter wave plate disposed on the display panel at an opposite side from the display surface side; and a polarizing plate disposed on the quarter wave plate at an opposite side from a display panel side, the polarizing plate having an absorption axis whose crossing angle relative to a slow axis of the quarter wave plate is set such that light passing through the polarizing plate and then passing through the quarter wave plate is converted into elliptically polarized light.

According to this configuration, light incident on the display panel from the display surface side is reflected by the light reflection part, for use in reflective display. On the other hand, light incident on the display panel from the opposite side from the display surface side passes through the light transmission part, for use in transmissive display. The light for use in the transmissive display passes through the polarizing plate, so that the light is converted into linearly polarized light. The linearly polarized light then passes through the quarter wave plate. It is assumed herein that the linearly polarized light, which has passed through the polarizing plate, passes through the quarter wave plate, so that the linearly polarized light is converted into circularly polarized light. In this case, contrast performance is excellent since leakage light is less prone to be caused during black display. However, since leakage light to be caused not a little during black display contains light with a specific hue in a relatively large amount, the leakage light with the specific hue is apt to be visually recognized with ease.

In this respect, the polarizing plate has the absorption axis whose crossing angle relative to the slow axis of the quarter wave plate is set such that light passing through the polarizing plate and then passing through the quarter wave plate is converted into elliptically polarized light. Therefore, the linearly polarized light, which has passed through the polarizing plate, passes through the quarter wave plate, so that the linearly polarized light is converted into elliptically polarized light. Accordingly, although the leakage light during the black display is increased in total amount, which leads to degradation in contrast performance, leakage light in a color other than the specific color is also increased in amount during the black display. The leakage light during the black display is thus less prone to be visually recognized with the specific hue.

### Advantageous Effect of the Invention

According to the present invention, leakage light can be less prone to be visually recognized with a specific hue.

### BRIEF DESCRIPTION OF THE DRAWINGS

FIG. 1 is a sectional view of a liquid crystal panel in a liquid crystal display device according to a first embodiment of the present invention.

FIG. 2 is a plan view of a liquid crystal panel, and illustrates a horizontal direction, an absorption axis of a polarizing plate, and a slow axis of a quarter wave plate.

FIG. 3 is a table of experimental results according to Examples 1 to 10 of Comparative Experiment 1.

FIG. 4 is a graph of a relationship between crossing angles and contrast ratios according to Examples 1 to 10 of Comparative Experiment 1.

FIG. 5 is an enlarged graph of a region on a low contrast ratio side in FIG. 4.

### MODES FOR CARRYING OUT THE INVENTION

### First Embodiment

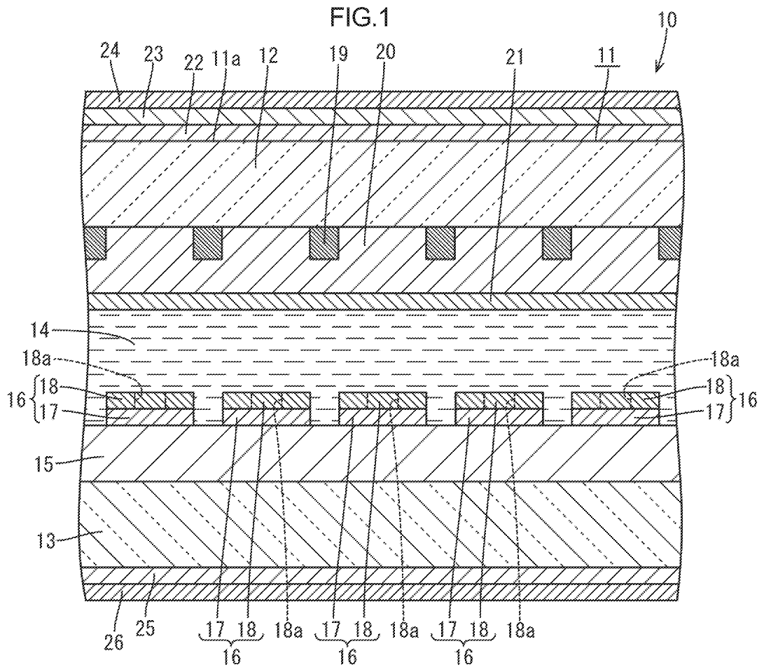

With reference to FIGS. 1 to 5, a description will be given of a first embodiment of the present invention. The present embodiment exemplifies a transflective liquid crystal display device 10.

As illustrated in FIG. 1, the liquid crystal display device 10 includes a transflective liquid crystal panel (a display panel) 11, and a backlight device (a lighting device) configured to irradiate the liquid crystal panel 11 with light. The liquid crystal panel 11 is a “transflective” liquid crystal panel since the liquid crystal panel 11 is configured to achieve both of reflective display and transmissive display. For use in the reflective display, the liquid crystal panel 11 allows reflection of external light (ambient light, environmental light) that is received at a display surface 11a side (a front side, a front surface side, an upper side in FIG. 1) thereof. For use in the transmissive display, the liquid crystal panel 11 allows transmission of light (backlight) that is emitted by the backlight device disposed at an opposite side (a back side, a back surface side, a lower side in FIG. 1) from the display surface 11a side. Examples of the external light for use in the reflective display include, but not limited to, sunlight and room light. The backlight device includes, for example, a light source (e.g., an LED) disposed on the liquid crystal panel 11 at an opposite side from the display surface 11a side and configured to emit light in white (white light), and an optical member configured to convert light from the light source into planar light by optical action. The backlight device can emit toward the liquid crystal panel 11 planar white light with substantially uniform luminance distribution within a plane of a display surface 11a of the liquid crystal panel 11. It should be noted that the backlight device is not illustrated in the drawings.

A specific description will be given of a configuration of the liquid crystal panel 11. As illustrated in FIG. 1, the liquid crystal panel 11 includes, at least, a pair of front and back substrates 12 and 13 opposing each other with an internal space defined therebetween, and a liquid crystal layer (a liquid crystal) 14 containing a liquid crystal molecule being a substance whose optical characteristics are changed by application of an electric field, the liquid crystal layer 14 being sandwiched between the substrates 12 and 13 and disposed in the internal space. Of the substrates 12 and 13, a substrate disposed at the front side (the display surface 11a side) is a counter substrate (a first substrate, a CF substrate, a common substrate) 12, whereas a substrate disposed at the back side (the opposite side from the display surface 11a side, a backlight device side) is an array substrate (a second substrate, an element substrate, an active matrix substrate, a TFT substrate) 13. The liquid crystal layer 14 is sealed with a seal part (not illustrated) interposed between outer peripheral ends of the substrates 12 and 13. The liquid crystal layer 14 is made of a liquid crystal material having positive dielectric anisotropy, and a liquid crystal molecule of the liquid crystal material is twisted by about 90° in a twisted nematic (TN) mode. In the present embodiment, the liquid crystal layer 14 has a retardation (d·Δn) of, for example, 195 nm. The liquid crystal panel 11 has a display region where an image is displayed, and a non-display region where an image is not displayed. The display region is located at a central portion of the display surface 11a, and the non-display region is located at a frame-shaped outer peripheral portion of the display surface 11a so as to surround the display region. The seal part and the like are disposed on the non-display region, and a pixel part 16 and the like for displaying an image are disposed on the display region. Each of the substrates 12 and 13 has a stacked structure, and includes an almost transparent glass substrate and films stacked on the glass substrate by, for example, the known photolithography. The liquid crystal panel 11 achieves monochrome display in the display region. When being not electrified (i.e., when no voltage is applied to a pixel part 16 to be described later), the liquid crystal panel 11 is in a normally black mode in which the liquid crystal panel 11 takes the minimum gradation value (transmittance) to achieve black display.

In the display region of the array substrate 13, as illustrated in FIG. 1, a large number of pixel parts 16 are arranged in a matrix shape in plan view within the plane of the display surface 11a. Each of the pixel parts 16 includes a transmissive pixel electrode (a light transmission part) 17 and a reflective pixel electrode (a light reflection part) 18 stacked (superimposed) on the transmissive pixel electrode 17. The transmissive pixel electrode 17 is disposed at a relatively lower side (an opposite side from a liquid crystal layer 14 side), and is formed of a transparent electrode film (a light transmission film). The reflective pixel electrode 18 is disposed at a relatively upper side (the liquid crystal layer 14 side), and is formed of a metal film (a light reflection film). Since the transmissive pixel electrode 17 is formed of the transparent electrode film that allows transmission of light, the transmissive pixel electrode 17 allows transmission of light from the backlight device, the light being received at an array substrate 13 side. Since the reflective pixel electrode 18 is formed of the metal film that allows reflection of light, the reflective pixel electrode 18 allows reflection of external light that is received at a counter substrate 12 side through the liquid crystal layer 14. Light reflected by the reflective pixel electrode 18 travels again toward the counter substrate 12 through the liquid crystal layer 14, for use in the reflective display. The reflective pixel electrode 18 partially has a through-hole 18a. Light that is emitted by the backlight device and passes through the transmissive pixel electrode 17 passes the through-hole 18a. The light, which has passed the through-hole 18a, travels toward the counter substrate 12 through the liquid crystal layer 14, for use in the transmissive display. A planarization film 15 is disposed on the array substrate 13 and below the transmissive pixel electrodes 17. The planarization film 15 is disposed for planarizing irregularities caused by, for example, wires and TFTs (not illustrated) disposed below the planarization film 15 and connected to the pixel parts 16. The planarization film 15 is mainly made of an organic insulating material. The planarization film 15 has a planarized surface on which the pixel parts 16 are disposed.

As illustrated in FIG. 1, at least a light shield part 19 configured to shield light, a blue color filter 20 configured to allow selective transmission of light in a blue wavelength range, and a counter electrode 21 disposed to oppose the pixel parts 16 are disposed on or above the counter substrate 12. The light shield part 19 has a grid shape in plan view so as to serve as a partition for the pixel parts 16 arranged in the matrix shape in plan view in the display region. The light shield part 19 shields light traveling between adjoining two of the pixel parts 16, thereby ensuring individual display of each pixel part 16. The blue color filter 20 is colored in blue. Specifically, the blue color filter 20 contains a pigment or a dye that allows selective transmission of blue light in a blue wavelength range (about 420 nm to about 500 nm) and absorbs light (green light, red light) in wavelength ranges other than the blue wavelength range. In the transflective liquid crystal panel 11 described in the present embodiment, external light for use in the reflective display is generally lower in color temperature than light from the backlight device for use in the transmissive display, and a color to be displayed during the reflective display is apt to become more yellowish than a color to be displayed during the transmissive display. Also in the transflective liquid crystal panel 11, the constituent members other than the blue color filter 20 are apt to have yellowish spectral characteristics. Owing to this, the color to be displayed during the reflective display becomes yellowish with ease. In this respect, since the blue color filter 20 colored in blue as a complementary color of yellow is disposed on the counter substrate 12, the color displayed during the reflective display is less prone to become yellowish. The blue color filter 20 is formed to be almost solid on the counter substrate 12 so as to be superimposed in plan view on all the large number of pixel parts 16 in the display region. The counter electrode 21 is formed of a transparent electrode film as in the transmissive pixel electrode 17, and always receives a certain reference potential (common potential). A potential difference based on voltages applied to the respective pixel parts 16 may therefore be caused between the counter electrode 21 and each pixel part 16 opposing the counter electrode 21. The use of the potential difference enables control of an alignment state of the liquid crystal material in the liquid crystal layer 14 near each of the pixel parts 16, thereby achieving display on the pixel parts 16. The counter electrode 21 is formed to be almost solid above the counter substrate 12 so as to oppose all the large number of pixel parts 16 in the display region.

As illustrated in FIG. 1, a quarter wave plate 22, a half wave plate 23, and a polarizing plate 24 are mounted in this order on a front-side one of the two outer surfaces (i.e., an outer surface at the display surface 11a side) of the liquid crystal panel 11, the two outer surfaces facing opposite sides from a liquid crystal layer 14 side. In addition, a quarter wave plate 25 and a polarizing plate 26 are mounted in this order on a back-side one of the two surfaces (i.e., an outer surface at the opposite side from the display surface 11a side) of the liquid crystal panel 11. Each of the pair of quarter wave plates 22 and 25 gives a phase difference by a quarter wavelength to light passing therethrough. The front-side quarter wave plate 22 has a retardation (d·Δn) of, for example, 110 nm. The back-side quarter wave plate 25 has a retardation of, for example, 140 nm larger than that of the front-side quarter wave plate 22. The half wave plate 23 gives a phase difference by a half wavelength to light passing therethrough, and has a retardation of, for example, 270 nm. During at least the reflective display, the action of optical compensation in a wide wavelength range of light can be obtained by the front-side quarter wave plate 22 and the front-side half wave plate 23. Each of the pair of polarizing plates 24 and 26 allows selective transmission of light that vibrates in a specific direction (a direction along a transmission axis), and extracts linearly polarized light from non-polarized light such as natural light.

As illustrated in FIG. 1, light from the backlight device for use in the transmissive display passes through the back-side polarizing plate 26, so that the light is converted into linearly polarized light. The linearly polarized light then passes through the back-side quarter wave plate 25. It is assumed herein that the linearly polarized light, which has passed through the polarizing plate 26, passes through the quarter wave plate 25, so that the linearly polarized light is converted into circularly polarized light. In this case, contrast performance is excellent since the leakage light is less prone to be caused during the black display. On the other hand, since the leakage light to be caused not a little during the black display contains light with a specific hue in a relatively large amount, the leakage light with the specific hue is apt to be visually recognized by a user with ease. In the present embodiment, specifically, since the liquid crystal panel 11 includes the blue color filter 20, there is a possibility that the leakage light during the black display is visually recognized with a bluish hue by the user when the leakage light passes through the blue color filter 20.

In the present embodiment, hence, the back-side polarizing plate 26 is disposed on the back-side quarter wave plate 25 at the opposite side from the liquid crystal panel 11 side, as illustrated in FIG. 1. In addition, the back-side polarizing plate 26 has an absorption axis 26a whose crossing angle θc relative to a slow axis 25a of the quarter wave plate 25 is set such that light passing through the polarizing plate 26 and then passing through the quarter wave plate 25 is converted into elliptically polarized light. The absorption axis 26a of the polarizing plate 26 extends along a plane of the polarizing plate 26, and is orthogonal to a transmission axis of the absorption axis 26a. The slow axis 25a of the quarter wave plate 25 extends along a plane of the quarter wave plate 25, and is orthogonal to a fast axis of the quarter wave plate 25. According to this configuration, in the transmissive display, light from the backlight device passes through the back-side polarizing plate 26, so that the light is converted into linearly polarized light. The linearly polarized light then passes through the quarter wave plate 25, so that the linearly polarized light is converted into elliptically polarized light. Accordingly, although the leakage light during the black display is increased in total amount, which leads to degradation in contrast performance, leakage light in a specific color, that is, leakage light in a color (green, red) other than blue is also increased in amount during the black display. As a result, the leakage light during the black display has an almost whitely hue, which is less prone to be visually recognized with the specific hue (bluish hue).

### Comparative Experiment 1

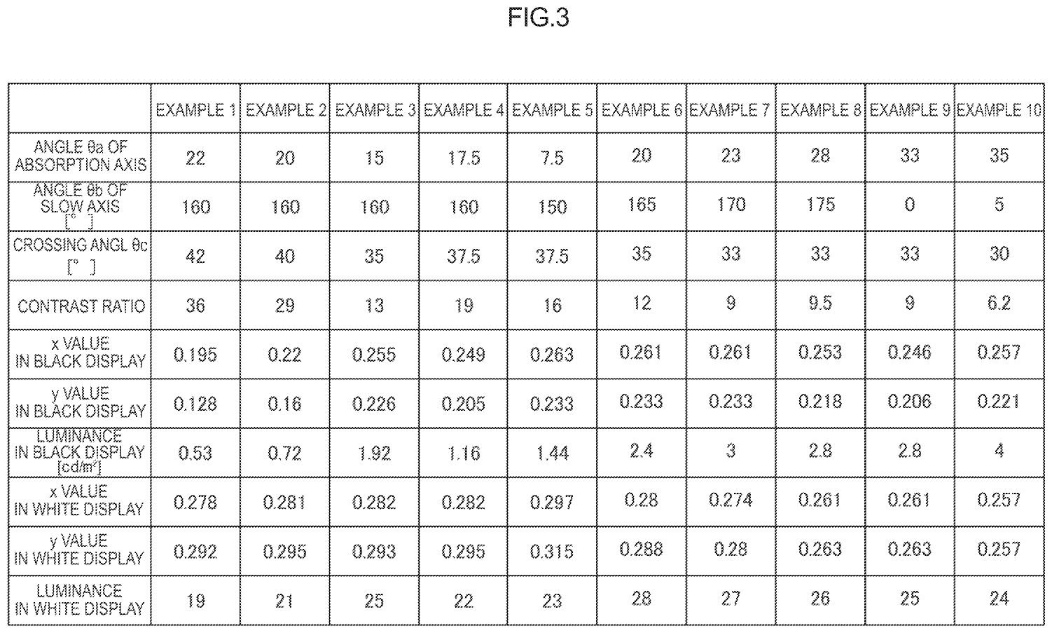

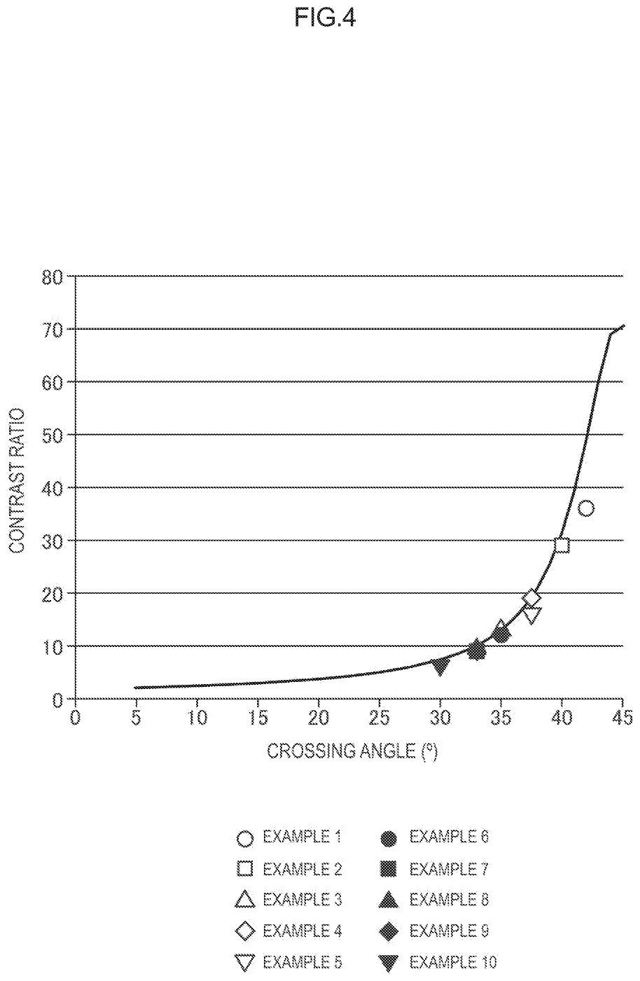

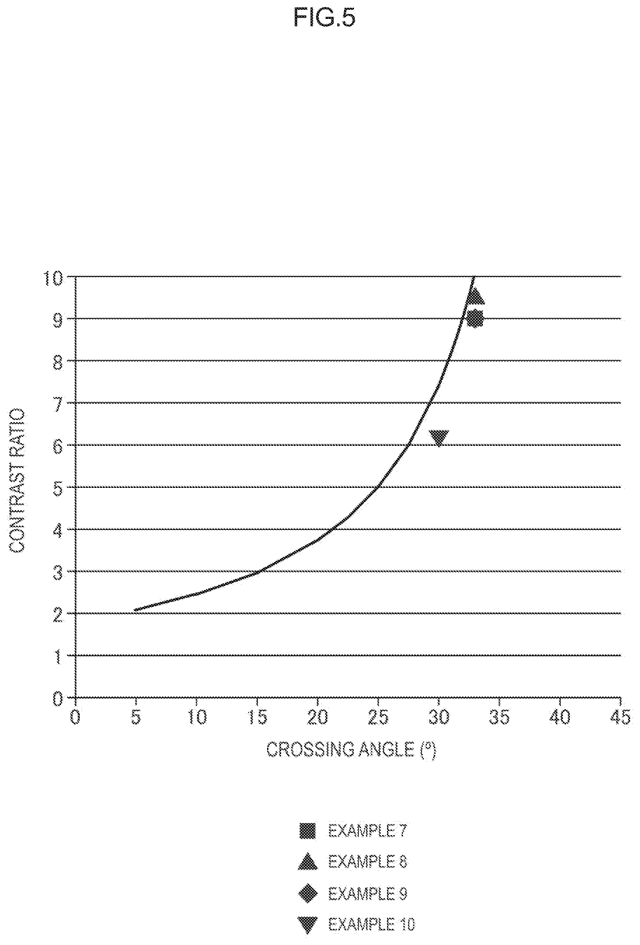

Comparative Experiment 1 was conducted as will be described below in order to gain findings about how a contrast ratio and the like are changed during the transmissive display by changing the crossing angle θc of the absorption axis 26a of the polarizing plate 26 relative to the slow axis 25a of the quarter wave plate 25. In Comparative Experiment 1, transmissive display was carried out in accordance with Examples 1 to 10 in which the crossing angle θc was changed in a range from 30° to 42°. A contrast ratio in the transmissive display, a chromaticity value and a luminance value in black display (display with minimum gradation), as well as a chromaticity value and a luminance value in white display (display with maximum gradation) were respectively measured. FIGS. 3 to 5 each illustrate the results of measurement. In a table of FIG. 3, the contrast ratio is obtained by dividing the luminance value in the white display by the luminance value in the black display, and is expressed in no unit. Also in the table of FIG. 3, the chromaticity values are respectively x values and y values in the CIE1931 chromaticity diagram. Also in the table of FIG. 3, the luminance values are expressed in a unit of “cd/m²”. FIGS. 4 and 5 are graphs each illustrating a simulation curve (a theoretical value) calculated from data on element parameters of the respective constituent elements of the liquid crystal panel 11, and the plotted contrast ratios and crossing angles θc as the experimental results according to Examples 1 to 10. In each of the graphs, the horizontal axis represents the crossing angle θc, and the vertical axis represents the contrast ratio. FIG. 5 is an enlarged graph of a region on a low contrast ratio side in FIG. 4 (i.e., a region where the contrast ratio takes a value in a range from 0 to 10). In carrying out the transmissive display, an illuminant C that emits standard white light or a light source that emits white light approximate to the standard white light is used as the backlight device configured to irradiate the liquid crystal panel 11 with light.

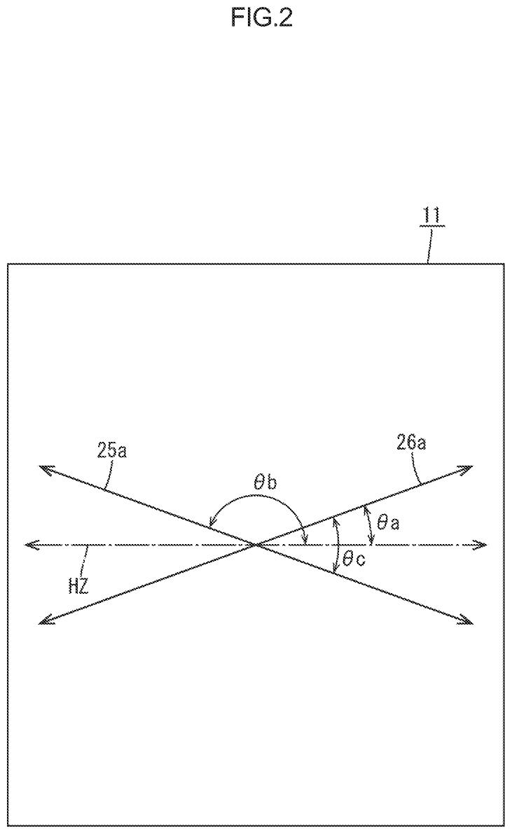

As illustrated in FIGS. 2 and 3, in Example 1, an angle θa of the absorption axis 26a of the polarizing plate 26 relative to a horizontal direction HZ defined as a reference is set at 22°, an angle θb of the slow axis 25a of the quarter wave plate 25 relative to the horizontal direction HZ is set at 160°, and the crossing angle θc of the absorption axis 26a relative to the slow axis 25a is set at 42°. In the present embodiment, the shorter-side direction of the liquid crystal panel 11 having a rectangular shape elongated longitudinally corresponds to the referential horizontal direction HZ. In Example 2, the angle θa of the absorption axis 26a is set at 20°, the angle θb of the slow axis 25a is set at 160°, and the crossing angle θc is set at 40°. In Example 3, the angle θa of the absorption axis 26a is set at 15°, the angle θb of the slow axis 25a is set at 160°, and the crossing angle θc is set at 35°. In Example 4, the angle θa of the absorption axis 26a is set at 17.5°, the angle θb of the slow axis 25a is set at 160°, and the crossing angle θc is set at 37.5°. In Example 5, the angle θa of the absorption axis 26a is set at 7.5°, the angle θb of the slow axis 25a is set at 150°, and the crossing angle θc is set at 37.5°. In Example 6, the angle θa of the absorption axis 26a is set at 20°, the angle θb of the slow axis 25a is set at 165°, and the crossing angle θc is set at 35°. In Example 7, the angle θa of the absorption axis 26a is set at 23°, the angle θb of the slow axis 25a is set at 170°, and the crossing angle θc is set at 33°. In Example 8, the angle θa of the absorption axis 26a is set at 28°, the angle θb of the slow axis 25a is set at 175°, and the crossing angle θc is set at 33°. In Example 9, the angle θa of the absorption axis 26a is set at 33°, the angle θb of the slow axis 25a is set at 0°, and the crossing angle θc is set at 33°. In Example 1°, the angle θa of the absorption axis 26a is set at 35°, the angle θb of the slow axis 25a is set at 5°, and the crossing angle θc is set at 30°.

A description will be given of the experimental results of Comparative Experiment 1. As illustrated in FIG. 3, according to Examples 3 to 10, as compared with Examples 1 and 2, the x values and y values in the black display are increased to values relatively close to target white. In Comparative Experiment 1, as to a chromaticity value for target white in the black display, for example, the x value is set at 0.2456, and the y value is set at 0.2053. Therefore, when the crossing angle θc is set at 37.50 or less as in Examples 3 to 10, the leakage light in blue (the specific color) and the leakage light in a color other than blue are satisfactorily increased during the black display. As a result, the leakage light during the black display has a hue closer to target white, and is therefore further less prone to be visually recognized with a bluish hue (the specific hue). According to Examples 1 to 10, each of the contrast ratios is ensured by at least 6 or more. Therefore, when the crossing angle θc is set at 300 or more as in Examples 1 to 10, the total amount of leakage light during the black display can be further reduced, and the contrast ratio can be ensured by at least 6 or more. Satisfactory display performance is thus obtained.

More specifically, as illustrated in FIG. 3, according to Examples 4 and 5, as compared with Examples 1 to 3, the x values and y values in the black display are increased to values relatively close to target white. According to Examples 4 and 5, each of the contrast ratios is ensured by at least 16 or more which is relatively larger than the contrast ratios (6.2 to 12) in Examples 6 to 10. Therefore, when the crossing angle θc is set at 37.50 as in Examples 4 and 5, the leakage light in blue (the specific color) and the leakage light in a color other than blue are further increased during the black display. As a result, the leakage light during the black display has a hue closer to target white, and is therefore further less prone to be visually recognized with a bluish hue (the specific hue). In addition, when the crossing angle θc is set at 37.50 as in Examples 4 and 5, the total amount of leakage light during the black display can be further reduced, and the contrast ratio can be ensured by at least 16 or more. Higher display performance is thus obtained.

As illustrated in FIG. 3, according to Example 9, as compared with Examples 1 to 3, 5 to 8, and 10, the chromaticity value in the black display reaches a value relatively close to target white. According to Example 9, the contrast ratio is ensured by at least about 9 which is relatively larger than the contrast ratio (6.2) in Example 10. Therefore, in the case where the angle θb of the slow axis 25a relative to the horizontal direction HZ is set at 0° so that the slow axis 25a is disposed to be aligned with the horizontal direction HZ, and the angle θa of the absorption axis 26a is set at 33° as in Example 9, when the crossing angle θc is set 330, the leakage light in blue (the specific color) and the leakage light in a color other than blue are further increased during the black display, as compared with the case where the slow axis 25a crosses the horizontal direction HZ. As a result, the leakage light during the black display has a hue closer to target white, and is therefore further less prone to be visually recognized with a bluish hue (the specific hue). In addition, when the crossing angle θc is set at 330 as in Example 9, the total amount of leakage light during the black display can be satisfactorily reduced, and the contrast ratio can be ensured by at least about 9. Satisfactory display performance is thus obtained.

As illustrated in FIGS. 4 and 5, preferably, the numerical range of the crossing angle θc is set to be larger than 15° and smaller than 45°. When the crossing angle θc is smaller than 45°, linearly polarized light, which has passed through the polarizing plate 26, is converted into elliptically polarized light rather than circularly polarized light as the linearly polarized light passes through the quarter wave plate 25. Therefore, the leakage light in blue (the specific color) and the leakage light in a color other than blue are satisfactorily increased during the black display. As a result, the leakage light during the black display has a hue close to target white, and is therefore less prone to be visually recognized with a bluish hue (the specific hue). As indicated by an approximate curve in FIG. 5, when the crossing angle θc is larger than 15°, the total amount of leakage light during the black display is not increased excessively, and the contrast ratio is increased to be larger than at least 3. Minimum display performance can thus be obtained.

As described above, the liquid crystal display device (the display device) 10 according to the present embodiment includes: the liquid crystal panel (the display panel) 11 including the reflective pixel electrode (the light reflection part) 18 by which light from the display surface 11a side is reflected, and the transmissive pixel electrode (the light transmission part) 17 through which light from the opposite side from the display surface 11a side passes; the quarter wave plate 25 disposed on the liquid crystal panel 11 at the opposite side from the display surface 11a side; and the polarizing plate 26 disposed on the quarter wave plate 25 at the opposite side from the liquid crystal panel 11 side, the polarizing plate 26 having the absorption axis 26a whose crossing angle θc relative to the slow axis 25a of the quarter wave plate 25 is set such that light passing through the polarizing plate 26 and then passing through the quarter wave plate 25 is converted into elliptically polarized light.

According to this configuration, light incident on the liquid crystal panel 11 from the display surface 11a side is reflected by the reflective pixel electrode 18, for use in the reflective display. On the other hand, light incident on the liquid crystal panel 11 from the opposite side from the display surface 11a side passes through the transmissive pixel electrode 17, for use in the transmissive display. The light for use in the transmissive display passes through the polarizing plate 26, so that the light is converted into linearly polarized light. The linearly polarized light then passes through the quarter wave plate 25. It is assumed herein that the linearly polarized light, which has passed through the polarizing plate 26, passes through the quarter wave plate 25, so that the linearly polarized light is converted into circularly polarized light. In this case, contrast performance is excellent since leakage light is less prone to be caused during the black display. However, since leakage light to be caused not a little during the black display contains light with a specific hue in a relatively large amount, the leakage light with the specific hue is apt to be visually recognized with ease.

In this respect, the polarizing plate 26 has the absorption axis 26a whose crossing angle θc relative to the slow axis 25a of the quarter wave plate 25 is set such that light passing through the polarizing plate 26 and then passing through the quarter wave plate 25 is converted into elliptically polarized light. Therefore, the linearly polarized light, which has passed through the polarizing plate 26, passes through the quarter wave plate 25, so that the linearly polarized light is converted into elliptically polarized light. Accordingly, although the leakage light during the black display is increased in total amount, which leads to degradation in contrast performance, leakage light in a color other than the specific color is also increased in amount during the black display. The leakage light during the black display is thus less prone to be visually recognized with the specific hue.

The crossing angle θc of the polarizing plate 26 is set to be larger than 15° and smaller than 45°. As described above, when the crossing angle θc of the absorption axis 26a of the polarizing plate 26 relative to the slow axis 25a of the quarter wave plate 25 is smaller than 45°, linearly polarized light, which has passed through the polarizing plate 26, is converted into elliptically polarized light as the linearly polarized light passes through the quarter wave plate 25. When the crossing angle θc of the absorption axis 26a of the polarizing plate 26 relative to the slow axis 25a of the quarter wave plate 25 is larger than 15°, the total amount of leakage light during the black display is not increased excessively, and the contrast ratio is increased to be larger than at least 3. Minimum display performance can thus be obtained.

The crossing angle θc of the polarizing plate 26 is set to be 30° or more and 37.50 or less. As described above, when the crossing angle θc of the absorption axis 26a of the polarizing plate 26 relative to the slow axis 25a of the quarter wave plate 25 is 30° or more, the total amount of leakage light during the black display can be further reduced, and the contrast ratio can be ensured by at least 6 or more. Satisfactory display performance is thus obtained. On the other hand, when the crossing angle θc of the absorption axis 26a of the polarizing plate 26 relative to the slow axis 25a of the quarter wave plate 25 is 37.5° or less, leakage light in a color other than the specific color is satisfactorily increased during the black display. The leakage light during the black display is thus further less prone to be visually recognized with the specific hue.

The crossing angle θc of the polarizing plate 26 is set at 37.5°. According to this configuration, the total amount of leakage light during the black display can be further reduced, and the contrast ratio can be ensured by at least 16 or more. Higher display performance is thus obtained. On the other hand, when the crossing angle θc of the absorption axis 26a of the polarizing plate 26 relative to the slow axis 25a of the quarter wave plate 25 is 37.5°, leakage light in a color other than the specific color is further increased during the black display, as compared with the case where the crossing angle θc is larger than 37.5°. The leakage light during the black display thus has a hue approximate to white, and is therefore further less prone to be visually recognized with the specific hue.

The slow axis 25a of the quarter wave plate 25 is disposed to be aligned with a horizontal direction HZ in the display surface 11a, and the crossing angle θc of the polarizing plate 26 is set at 33°. As described above, when the crossing angle θc of the absorption axis 26a of the polarizing plate 26 relative to the slow axis 25a of the quarter wave plate 25 is 33°, the contrast ratio can be ensured by at least about 9. Satisfactory display performance is thus obtained. Since the slow axis 25a of the quarter wave plate 25 is aligned with the horizontal direction HZ in the display surface 11a, and the polarizing plate 26 has the absorption axis 26a whose crossing angle θc relative to each of the slow axis 25a and the horizontal direction HZ is 33°, leakage light in a color other than the specific color is further increased during the black display, as compared with the case where the slow axis 25a crosses the horizontal direction HZ. The leakage light during the black display thus has a hue approximate to white, and is therefore further less prone to be visually recognized with the specific hue.

The liquid crystal panel 11 includes the blue color filter 20 colored in blue and disposed to be superimposed on at least the reflective pixel electrode 18 and the transmissive pixel electrode 17. In the reflective display, light reflected by the reflective pixel electrode 18 is apt to become yellowish. However, since the blue color filter 20 is disposed to be superimposed on at least the reflective pixel electrode 18, the light reflected by the reflective pixel electrode 18 in the reflective display passes through the blue color filter 20. The light in the reflective display is thus less prone to become yellowish. On the other hand, in the transmissive display, light passes through the blue color filter 20 disposed to be superimposed on the transmissive pixel electrode 17, so that leakage light caused during the black display becomes bluish with ease. In this respect, the polarizing plate 26 has the absorption axis 26a whose crossing angle θc relative to the slow axis 25a of the quarter wave plate 25 is set such that light passing through the polarizing plate 26 and then passing through the quarter wave plate 25 is converted into elliptically polarized light. Therefore, leakage light in a color other than blue is also increased during the black display. The leakage light during the black display is thus less prone to be visually recognized with a bluish hue.

### Other Embodiments

The present invention is not limited to an embodiment based on the foregoing description and the drawings. For example, the following embodiments may also be encompassed in the technical scope of the present invention.

(1) As to the angle of the absorption axis, the angle of the slow axis, and the crossing angle, the specific numeric values are appropriately changeable in addition to those in Examples 1 to 10 of Comparative Experiment 1 in the first embodiment. For example, the numeric value of the crossing angle is not limited to the case of Comparative Experiment 1 where the crossing angle is smaller than 45°. Alternatively, the crossing angle may be larger than 45°. In the case where the crossing angle is larger than 45°, it is assumed that the numeric value of the contrast ratio tends to decrease as the crossing angle approaches 90°. It is therefore supposed that this case produces functions and effects similar to those in the case where the crossing angle is smaller than 45° as in Comparative Experiment 1.

(2) As to the retardations of the liquid crystal layer and wave plates, the specific numeric values are appropriately changeable in addition to those described in the first embodiment.

(3) In the first embodiment, the liquid crystal panel includes the blue color filter. Alternatively, the liquid crystal panel may include a color filter in a color (e.g., green, red) other than blue. Still alternatively, the liquid crystal panel does not necessarily include a color filter.

(4) In the first embodiment, the shorter-side direction of the liquid crystal panel is defined as the horizontal direction. Alternatively, the longer-side direction of the liquid crystal panel may be defined as the horizontal direction.

(5) Each of the foregoing embodiments exemplifies the transflective liquid crystal panel having the configuration in which the liquid crystal layer is sandwiched between the pair of substrates. The present invention is also applicable to a display panel in which a functional organic molecule other than a liquid crystal material is sandwiched between a pair of substrates.

(6) The transflective liquid crystal panel may operate in any of a vertical alignment (VA) mode, an in-plane switching (IPS) mode, a fringe field switching (FFS) mode, and the like.

### EXPLANATION OF SYMBOLS

10: Liquid crystal display device (Display device)
11: Liquid crystal panel (Display panel)
11a: Display surface
17: Transmissive pixel electrode (Light transmission part)
18: Reflective pixel electrode (Light reflection part)
20: Blue color filter
25: Quarter wave plate
25a: Slow axis
26: Polarizing plate
26a: Absorption axis
HZ: Horizontal direction
θc: Crossing angle

1. A display device comprising:
a display panel including a light reflection part by which light from a display surface side is reflected, and a light transmission part through which light from an opposite side from the display surface side passes;
a quarter wave plate disposed on the display panel at an opposite side from the display surface side; and
a polarizing plate disposed on the quarter wave plate at an opposite side from a display panel side, the polarizing plate having an absorption axis whose crossing angle relative to a slow axis of the quarter wave plate is set such that light passing through the polarizing plate and then passing through the quarter wave plate is converted into elliptically polarized light.

2. The display device according to claim 1, wherein the crossing angle of the polarizing plate is set to be larger than 15° and smaller than 45°.

3. The display device according to claim 1, wherein the crossing angle of the polarizing plate is set to be 30° or more and 37.5° or less.

4. The display device according to claim 1, wherein the crossing angle of the polarizing plate is set at 37.5°.

5. The display device according to claim 1, wherein
the slow axis of the quarter wave plate is disposed to be aligned with a horizontal direction in the display surface, and
the crossing angle of the polarizing plate is set at 33°.

6. The display device according to claim 1, wherein the display panel includes a blue color filter colored in blue and disposed to be superimposed on at least the light reflection part and the light transmission part.
